(19) United States
(12) Patent Application Publication
(10) Pub. No.: US 2014/0244107 A1
(43) Pub. Date: Aug. 28, 2014

(54) BATTERY CHARGE VOLTAGE COMPENSATING SYSTEM AND METHOD OF OPERATION

(71) Applicant: C.E. NIEHOFF & CO., Evanston, IL (US)

(72) Inventors: Dimitar Delevski, Northbrook, IL (US); Issam Jabaji, Glenview, IL (US)

(73) Assignee: C.E. NIEHOFF & CO., Evanston, IL (US)

(21) Appl. No.: 13/781,202

(22) Filed: Feb. 28, 2013

(51) Int. Cl. B60L 1/00

(52) U.S. Cl. CPC B60L 1/00
USPC 701/36

(57) ABSTRACT

A vehicle electrical system comprises a generator providing electrical power to a first and a second electrical subsystems at a regulation voltage. A control device ascertains the voltage of the first electrical subsystem, the voltage of the second electrical subsystem, and/or the electrical current to the second electrical subsystem and utilizes a switch module to ensure that the voltage of the first electrical subsystem remains at a predetermined voltage. The control device may be further configured to regulate the output voltage of the generator at the regulation voltage and further to change the regulation voltage as a function of the generator output voltage and voltage of the second electrical subsystem and/or as a function of the electrical current to the second electrical subsystem.

### COPYRIGHT

A portion of the disclosure of this patent document contains material which is subject to copyright protection. The owner has no objection to the facsimile reproduction by anyone of the patent disclosure, as it appears in the Patent and Trademark. Office files or records, but otherwise reserves all copyright rights whatsoever.

### FIELD OF INVENTION

This invention is related to a vehicle electrical system including a generator or battery charger operative to provide electrical power to a first and a second electrical subsystem via a control device. In particular, the present invention relates to a control device which utilizes a switch module to control the voltages of the first electrical subsystem, second electrical subsystem and/or generator.

### BACKGROUND

The present invention seeks to address voltage control for a first and a second electrical subsystem which are electrically powered by a generator operating at a regulation voltage. In particular, the present invention discloses a vehicle electrical system which includes a generator operative to provide electrical power to a first and a second electrical subsystem where each of the first and second electrical subsystems includes at least one of an electrical load and an electrical power storage device such as a battery. The generator is coupled with the first electrical subsystem via a switch module. A control device utilizes the switch module, which according to one embodiment includes a diode and a relay switch, and it is configured to control the voltage of the first electrical subsystem, second electrical subsystem and/or generator. In one application, the control device uses the switch module to ensure that the voltage of the first electrical subsystem remains at a predetermined voltage. For instance, where the generator's regulation voltage changes according to operating conditions, the control device maintains the voltage of the first electrical subsystem at the predetermined voltage.

The control device maybe further configured to also operate as a voltage regulator. In addition, the control device may be further configured to change the regulation voltage of the generator in accordance with a difference between the generator output voltage and the voltage of the second electrical subsystem. For instance, where the second electrical subsystem is coupled with the generator via a long electrical cable, the control device may increase the generator's regulation voltage so as to compensate for the voltage drop across the electrical cable. Such voltage differences between the generator and second electrical subsystem may be caused by other factors such as utilization of an undersized electrical cable. The control device ascertains the voltages of the generator and second electrical subsystem and changes the generator regulation voltage according to these voltages. In an alternative embodiment, the control device ascertains the electrical current to the second electrical subsystem and varies the regulation voltage according to the electrical current.

The generator output terminal is coupled to an input terminal of the control device. According to one preferred embodiment, the generator output power through its output terminal is subsequently split into two, for consumption by the first and second electrical subsystems, via a first and second output terminal of the control device. According to another embodiment, the control device comprises only one output terminal which is coupled to the first electrical subsystem via the switch module. The electrical power connections between the generator and second electrical subsystem remain separate and outside of the control device.

In one preferred embodiment, the switch module is within the control device housing and it includes a diode electrically coupled with a switch in parallel. The portion of the generator output power, outputted from the first output terminal of the control device, flows through the diode-switch path to the first electrical subsystem. The remaining portion of the generator output power, outputted from the second output terminal of the control device, flows through electrical components such as an electrical cable which may cause or otherwise introduce a reduction in voltage at the second electrical subsystem. The control device measures or otherwise ascertains the voltages of the first electrical subsystem, second electrical subsystem, electrical current to the second electrical subsystem, and/or generator. It applies a control signal to the switch module so as to control the voltage of the first electrical subsystem. The switching of the switch module controls the voltage relationship between the first and second electrical subsystems The control device may be further configured to regulate the output voltage of the generator via a regulating circuit. The control device may be further configured to continuously change the generator regulation voltage according to a difference between the voltage of the first electrical subsystem and a predetermined voltage, a difference between the generator output voltage and the voltage of the second electrical subsystem and/or the electrical current to the second electrical subsystem.

Electrical systems, such as a vehicle electrical system, are typically comprised of a generator, electrical loads, and an electrical power storage device such as a battery. The battery functions during the time when the generator is not operating so as to provide the required electrical power to the electrical loads. When the vehicle mechanical engine is operating, the generator, driven by the engine, delivers electrical power to the electrical loads and battery. Larger more complex vehicle electrical systems are designed. so that the electrical system comprises two or more electrical subsystems each comprising of at least an electrical load and as battery. The electrical load may include one or a combination of starter motor, a heating element, an air conditioning unit, a compressor, a cooling fan, a pump, to name a few examples. Monitoring and control of voltages of the electrical subsystems are desirable.

In an illustrative example of a large vehicle electrical system, consider the one that includes a first and second electrical subsystem. The first electrical subsystem comprises a first electrical load and first battery. The second electrical subsystem comprises a second electrical load and second battery. Furthermore, consider the embodiment where the two electrical subsystems are spatially located at two different locations within the vehicle electrical system. The generator supplies electrical power to both electrical subsystems. Electrical power cables are commonly used to connect the generator to the electrical subsystems. Such electrical power cables, although having small electrical resistance, nevertheless introduce a reduction in voltage over their lengths. Long electrical power cables, utilized in large vehicle electrical systems, cause large enough voltage reductions at high current so as to require control of and harmony between the voltages of the first and second electrical subsystems.

Although in the above example the first and second electrical subsystems utilized long electrical power cables, the associated voltage drops may be caused by undersized cables even though they are of short lengths. In yet other applications, control of voltages of the first and second electrical subsystems is desirable regardless of spatial limitations of the vehicle electrical system. For instance, in one application where two different types of batteries are used, a difference between the voltages of the first and second electrical subsystems is required. The control device of the present invention operates to provide electrical output power from its output terminals at different voltages depending on the vehicle electrical system and operating conditions.

Although various systems have been proposed which touch upon some aspects of the above problems, they do not provide solutions to the existing limitations in providing electrical power to two electrical subsystems and further controlling the voltages of the generator and electrical subsystems. For example, Chen et al., U.S. Pat. App. No. 20090196081 discloses a system and method for providing switching to power regulators. The system includes a first voltage supply that is configured to provide a first voltage. The system also includes a second voltage supply that is configured to provide a second voltage. The second voltage is independent from the first voltage. The system additionally includes a controller component that is electrically coupled to the first voltage supply. Additionally, the system includes a gate driver component that is electrically coupled to the second voltage supply. The gate driver component is configured to receive at least the first output signal and generate a second output signal in response to at least the second voltage and the first output signal. However, Chen's system cannot provide electrical power to two electrical subsystems and further control the voltages of the generator and electrical subsystems.

Suzuki et al., U.S. Pat. App. No. 20080150436 discloses a chopper regulator circuit which consists of a power output portion for a first and a second load, a first output detection portion detecting the output to the first load, a second output detection portion detecting the output to the second load, a first and a second reference voltage generation portion, an output control portion controlling the amount of outputted electric power based on a result of comparison between two input voltages, and a switching control portion switching which of the first and second loads to supply electric power to and switching what voltages to handle as the input voltages. The input voltages are so switched that, when electric power is supplied to the first load, the detected voltage detected by the first output detection portion and the reference voltage generated by the first reference voltage generation portion are handled as the input voltages and, when electric power is supplied to the second load, the detected voltage detected by the second output detection portion and the reference voltage generated by the second reference voltage generation portion are handled as the input voltages, Thus, a chopper regulator circuit is realized that can easily supply two loads with adequate electric power with minimum disadvantages such as an increase in the total number of components needed, However, Suzuki's system is incapable of providing electrical power to two electrical subsystems and further controlling the voltages of the generator and electrical subsystems.

Koizumi, U.S. Pat. No. 5,801,581 discloses a detection circuit which includes a current mirror or circuit that produces electric currents at first and second output terminals in response to a current supplied to its input terminal. A first active load is connected to the first output terminal and a second active load is connected to the second output terminal and an external output terminal. A control circuit controls the potential of the control electrode of the second active load according to the voltage or the current at the first output terminal. The control circuit can include. a capacitive device that determines the voltage at the control electrodes of the active loads according to the peak value of current supplied to the current mirror circuit input terminal. However, Koizumi s system is also unable to provide electrical power to two electrical subsystems and further control the voltages of the generator and electrical subsystems

Large vehicle electrical systems comprise a large number of electrical components that consume large amounts of electrical power. Such systems use high power generators to meet the high electrical power requirement. They often employ multiple electrical subsystems which are powered by the generator. In such electrical systems, it is essential to accurately control the voltages of the generator and electrical subsystems. It is also advantageous to change the regulation voltage of the generator according to the operating conditions of the electrical subsystems.

As a simple, yet efficient, alternative to existing technologies, the present invention offers a vehicle electrical system including a generator that provides electrical power to two electrical subsystems at a regulation voltage. A control device monitors the voltages of the electrical subsystems and generator, or alternatively the electrical current to the electrical subsystems, and utilizes a switch module to accurately control the voltages of the electrical subsystems. The control device may be further configured as a voltage regulator for the generator. It may be further configured to change the regulation voltage as a function of the generator output voltage and voltage of the electrical subsystem and/or as a function of the electrical current to the electrical subsystem.

### SUMMARY

The present invention discloses a vehicle electrical system, including method of operation, comprising a generator which provides electrical power to a first and a second electrical subsystems at a regulation voltage. The electrical system further comprises a control device and a switch module which is coupled with the generator and first electrical subsystem, In its most basic mode of operation, the control device ascertains the voltage of the first electrical subsystem, the voltage of the second electrical subsystem, and/or the electrical current to the second electrical subsystem and utilizes the switch module to ensure that the voltage of the first electrical subsystem remains at a predetermined voltage. The control device may be further configured to regulate the output voltage of the generator at the regulation voltage and further to change the regulation voltage as a function of the generator output voltage and voltage of the second electrical subsystem and/or as a function of the electrical current to the second electrical subsystem.

In one aspect, a vehicle electrical system comprises a first electrical subsystem, a second electrical subsystem, a generator operative to provide electrical power at a regulation voltage to the first and second electrical subsystem, a switch module coupled with the generator and first electrical subsystem, and a control device coupled with at least one of the first electrical subsystem, second electrical subsystem, generator, and switch module, wherein the control device is configured to ascertain at least one of a first voltage of the first electrical subsystem, a second voltage of the second electrical subsystem, an output voltage of the generator, and electrical current to the second electrical subsystem, and apply a control signal to the switch module according to at least one of a difference between the first voltage and a first predetermined voltage, a difference between the output voltage of the generator and second voltage and the electrical current to the second electrical subsystem.

Preferably, the control signal comprises one of a step signal and a modulated signal. Preferably, the step signal comprises one of a switch on and a switch off signal. Preferably, the step signal is a switch off signal when at least one of the difference between the first voltage and first predetermined voltage and the difference between the output voltage and second voltage is greater than a threshold value. Preferably, the step signal is a switch off signal when the electrical current to the second electrical subsystem is greater than a threshold value. Preferably the step signal is a switch on signal when at least one of the difference between the first voltage and first predetermined voltage and the difference between the output voltage and second voltage is less than or equal to a threshold value. Preferably, the step signal is a switch on signal when the electrical current to the second electrical subsystem is less than or equal to a threshold value. Preferably, a duty cycle of the modulated signal is inversely proportional to at least one of the difference between the first voltage and first predetermined voltage and the difference between the output voltage, and second voltage. Preferably, a duty cycle of the modulated signal is inversely proportional to the electrical current to the second electrical subsystem.

Preferably, the control device is further configured to generate a signal indicative of a change in the regulation voltage according to at least one of the difference between the output voltage and second voltage and the electrical current to the second electrical subsystem. Preferably, the control device is configured to generate a signal to set the regulation voltage to a first predetermined voltage plus the difference between the output voltage and second voltage. Preferably, the control device is configured to generate a signal to set the regulation voltage to a first predetermined voltage plus a threshold value wherein the threshold value is proportional to the electrical current to the second electrical subsystem.

Preferably, the control device is further configured to regulate the output voltage of the generator at the regulation voltage. Preferably, the control device is further configured to change the regulation voltage according to at least one of the difference between the output voltage and second voltage and the electrical current to the second electrical subsystem. Preferably, the control device is configured to set the regulation voltage to a first predetermined voltage plus the difference between the output voltage and second voltage. Preferably, the control device is configured to set the regulation voltage to a first predetermined voltage plus a threshold value wherein the threshold value is proportional to the electrical current to the second electrical subsystem. Preferably, the control device is further configured to ascertain at least one of a first temperature of the first electrical subsystem and second temperature of the second electrical subsystem and change the first predetermined voltage according to the at least one of the first temperature and second temperature.

In another aspect, a method for controlling a vehicle electrical system is disclosed wherein the system comprises a first electrical subsystem, a second electrical subsystem, a generator operative to provide electrical power at a regulation voltage to the first and second electrical subsystem, and a switch module coupled with the generator and first electrical subsystem, wherein the method comprises ascertaining at least one of a first voltage of the first electrical subsystem, a second voltage of the second electrical subsystem, an output voltage of the generator, and electrical current to the second electrical subsystem, and applying a control signal to the switch module according to at least one of a difference between the first voltage and a first predetermined voltage, a difference between the output voltage of the generator and second voltage, and the electrical current to the second electrical subsystem.

Preferably, the method further comprises generating a signal indicative of a change in the regulation voltage according to at least one of the difference between the output voltage and second voltage and the electrical current to the second electrical subsystem. Preferably, the method further comprises regulating the output voltage of the generator at the regulation voltage. Preferably, the method further comprises changing the regulation voltage according to at least one of the difference between the output voltage and second voltage and the electrical current to the second electrical subsystem. Preferably, the method further comprises ascertaining at least one of a first temperature of the first electrical subsystem and second temperature of the second electrical subsystem and changing the first predetermined voltage according to the at least one of the first temperature and second temperature.

In another aspect, a control device coupled with at least one of a first electrical, subsystem, a second electrical subsystem, a generator, and a switch module, said generator operative to provide electrical power at a regulation voltage to the first and second electrical subsystem, said switch module coupled with the generator and first electrical subsystem, said control device comprising a controller and wherein the controller is configured to measure at least one of a first voltage of the first electrical subsystem, a second voltage of the second electrical subsystem, an output voltage of the generator, and electrical current to the second electrical subsystem, via at least one of a first sense line, a second sense line, a third sense line, and a fourth sense line and apply a control signal, via a control line, to the switch module according to at least one of a difference between the first voltage and a first predetermined voltage, a difference between the output voltage of the generator and second voltage, and the electrical current to the second electrical subsystem.

Preferably, the control signal comprises one of a step signal and a modulated signal. Preferably, the step signal comprises one of a switch on and a switch off signal. Preferably, the step signal is a switch off signal when at least one of the difference between the first voltage and first predetermined voltage and the difference between the output voltage and second voltage is greater than a threshold value. Preferably, the step signal is a switch off signal when the electrical current to the second electrical subsystem is greater than a threshold value. Preferably, the step signal is a switch on signal when at least one of the difference between the first voltage and first predetermined voltage and the difference between the output voltage and second voltage is less than or equal to a threshold value. Preferably, the step signal is a switch on signal when the electrical current to the second electrical subsystem is less than or equal to a threshold value. Preferably, a duty cycle of the modulated signal is inversely proportional to at least one of the difference between the first voltage and first predetermined voltage and the difference between the output voltage and second voltage. Preferably, a duty cycle of the modulated signal is inversely proportional to the electrical current to the second electrical subsystem.

Preferably, the controller is further configured to generate a signal, via a communication line, indicative of a change in the regulation voltage according to at least one of the difference between the output voltage and second voltage and the electrical current to the second electrical subsystem. Preferably, the controller is configured to generate a signal, via the communication line, to set the regulation voltage to a first predetermined voltage plus the difference between the output voltage and second voltage. Preferably, the controller is configured to generate a signal, via the communication line, to set the regulation voltage to a first predetermined voltage plus a threshold value wherein the threshold value is proportional to the electrical current to the second electrical subsystem.

Preferably, the control device further comprises a regulating circuit and the controller is further configured to regulate the output voltage of the generator at the regulation voltage, via the regulating circuit. Preferably, the controller is further configured to change the regulation voltage according to at least one of the difference between the output voltage and second voltage and the electrical current to the second electrical subsystem. Preferably, the controller is configured to set the regulation voltage to a first predetermined voltage plus the difference between the output voltage and second voltage. Preferably, the controller is configured to set the regulation voltage to a first predetermined voltage plus a threshold value wherein the threshold value is proportional to the electrical current to the second electrical subsystem. Preferably, the controller is further configured to measure at least one of a first temperature of the first electrical subsystem and second temperature of the second electrical subsystem, via at least one of a fifth sense line and a sixth sense line and change the first predetermined voltage according to the at least one of the first temperature and second temperature.

In another aspect, a method for controlling at least one of a first electrical subsystem, a second electrical subsystem, and a generator, said generator operative to provide electrical power at a regulation voltage to the first and second electrical subsystem, said generator coupled with the first electrical subsystem via a switch module, wherein the method comprises measuring at least one of a first voltage of the first electrical subsystem, a second voltage of the second electrical subsystem, an output voltage of the generator, and electrical current to the second electrical subsystem, via at least one of a first sense line, a second sense line, a third sense line, and a fourth sense line and applying a control signal, via a control line, to the switch module according to at least one of a difference between the first voltage and a first predetermined voltage a difference between the output voltage of the generator and second voltage, and the electrical current to the second electrical subsystem.

Preferably, the method further comprises generating a signal, via a communication line, indicative of a change in the regulation voltage according to at least one of the difference between the output voltage and second voltage and the electrical current to the second electrical subsystem. Preferably, the method further comprises regulating the output voltage of the generator at the regulation voltage, via a regulating circuit. Preferably, the method further comprises changing the regulation voltage according to at least one of the difference between the output voltage and second voltage and the electrical current to the second electrical subsystem. Preferably, the method further comprises measuring at least one of a first temperature of the first electrical subsystem and second temperature of the second electrical subsystem, via at least one of a fifth sense line and a sixth sense line and changing the first predetermined voltage according to the at least one of the first temperature and second temperature.

### BRIEF DESCRIPTION OF THE DRAWINGS

FIG. 1 shows a block diagram of a vehicle electrical system comprising a generator coupled with a first electrical subsystem via a switch module within a control device and a second electrical subsystem via a long electrical cable, wherein the control device utilizes the switch module to compensate for the voltage drop across the electrical cable according to a preferred embodiment.

FIG. 2 shows a schematic diagram of the electrical connections between the various components within the vehicle electrical system of FIG. 1 according to a preferred embodiment.

FIG. 3 is a flow diagram of one preferred method of controlling a vehicle electrical system.

FIG. 4 is a flow diagram of one preferred method of controlling a first electrical subsystem, a second electrical subsystem, and a generator via a switch module.

FIG. 5 is a flow diagram of one preferred method of operation of the control device of FIG. 1 or 2 that maybe implemented on a processor, included in the control device, further detailing the conditions under which the control device switches the switch module to control the voltages of the first electrical subsystem, second electrical subsystem, and generator.

FIG. 6 is a flow diagram of one preferred method of operation of the control device of FIG. 1 or 2 that maybe implemented on a processor, included in the control device, further detailing the conditions under which the control device switches the switch module to control the voltages of the first electrical subsystem, second electrical subsystem, and generator.

FIG. 7 is a flow diagram of one preferred method of operation of the control device of FIG. 1 or 2 that maybe implemented on a processor, included in the control device, further detailing the conditions under which the control device switches the switch module to control the voltages of the first electrical subsystem, second electrical subsystem, and generator.

### DETAILED DESCRIPTION OF THE PRESENTLY PREFERRED EMBODIMENTS

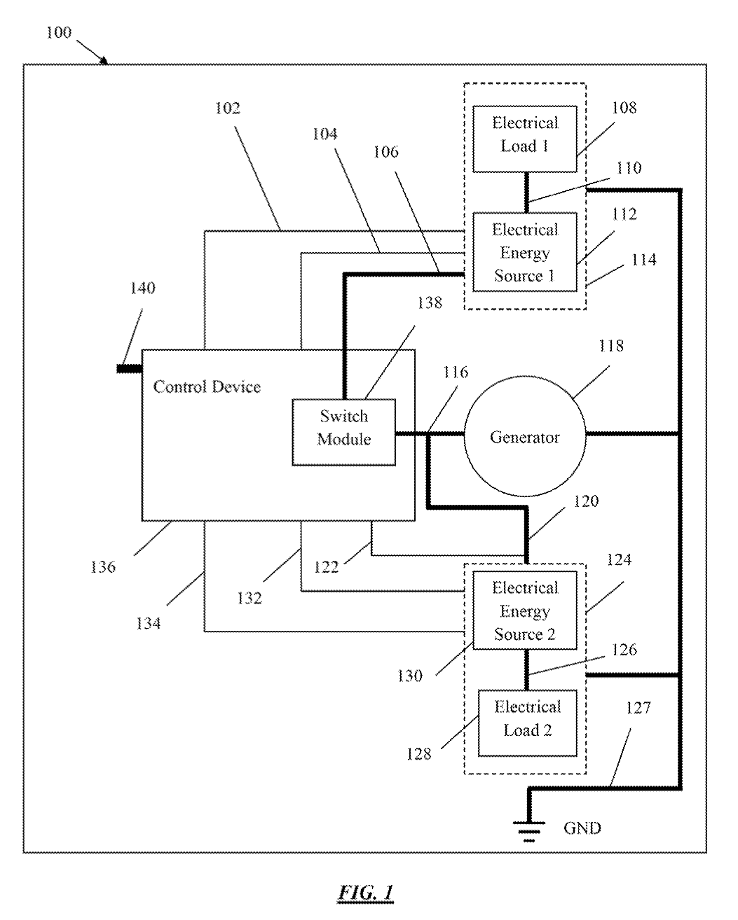

FIG. 1 depicts a block diagram of a preferred embodiment of a vehicle electrical system 100, including a generator 118, a first electrical subsystem 114 and a second electrical subsystem 124 commonly grounded at 127. The first electrical subsystem includes an electrical energy source 112 and electrical load 108. The second electrical subsystem 124 includes an electrical energy source 130 and electrical load 128. The vehicle electrical system 100 further comprises a control device 136 which includes a switch module 138 and an I/O port 140. The control device 136 utilizes the switch module 138 to ensure that the voltage of the first electrical subsystem 114 remains at a predetermined voltage. The control device 136 may be further configured to regulate the output voltage of the generator 118 at a regulation voltage and further to change the regulation voltage as a function of the generator output voltage and voltage of the second electrical subsystem 124 and/or as a function of the electrical current to the second electrical subsystem. The control device 136 can communicate system information to other components via one or more communication lines (not shown but known to artisans of ordinary skill).

The generator 118 is connected to the first electrical subsystem 114 via line 116, switch module 138, and line 106. The generator 118 is further connected to the second electrical subsystem 124 via line 120. In this preferred embodiment, the lines 116 and 120 branch out from a common output terminal of the generator 118. The control device 136 is connected to and in communication with the first electrical subsystem 114 via, sense lines 102 and 104, The control device 136 measures the voltage of the first electrical subsystem 114 via the sense line 102 and temperature of the first electrical subsystem 114 via the sense line 104. The control device 136 is connected to and in communication with the second electrical subsystem 124 via sense lines 134, 132, and 122. The control device 136 measures the voltage of the second electrical subsystem 124 via the sense line 134, temperature of the second electrical subsystem 124 via the sense line 132, and electrical current to the second electrical subsystem 124 via the sense line 122.

The first and second electrical energy sources 112 and 130 maybe a battery capacitor, DC/DC converter, fuel cell or a combination thereof The first and second electrical loads 108 and 128 may be one or a combination of heating element, an air conditioning unit, a compressor, a cooling fan, a pump, to name a few examples. The switch module 138 maybe one or more of a metal oxide semiconductor field effect transistor, a diode, a Schottky diode, and a mechanical relay switch. The switch module 110 may be packaged separately or integrated in a single housing. A bi-directional switch module, such as the one disclosed in the commonly owned U.S. Pat. No. 7,432,613 entitled “SELF-PROTECTIVE HIGH-CURRENT LOW-LOSS BI-DIRECTIONAL SEMICONDUCTOR SWITCH MODULE AND METHOD OF OPERATION” incorporated herein by reference in its entirety, may also be utilized.

The control device 136 includes a controller which may be analog or digital such as a microprocessor. In one preferred embodiment, the microprocessor is a 68HC08 processor having internal flash memory available from Freescale of Austin, Texas. It is contemplated that the processor may be a combination of individual discrete or separate integrated circuits packaged in a single housing or it may be fabricated in a single integrated circuit. The control device 136 is configured to measure one or a combination of voltage level, current level, and temperature associated with the first and second electrical subsystems 114 and 124, and to apply one or more control signals to the switch module 138 in response to these measurements.

The generator 118 provides electrical power at a regulation voltage V_{R} to the first and second electrical subsystem 114 and 124, respectively. In this preferred embodiment, the generator 118 comprises a voltage regulator (not shown but known to artisans of ordinary skill) which regulates the output voltage V_{G} of the generator 118 at the regulation voltage V_{R}. For an exemplary vehicle electrical system, the regulation voltage V_{R} of the generator 118 may be maintained, via the voltage regulator, at a predetermined voltage V_{S} equal to 14V, for instance.

The line 120 represents an electrical cable whose electrical resistance is such that there is a measurable difference between the generator output voltage V_{G} and the voltage V₂ of the second electrical subsystem 124. The voltage regulator measures the difference ΔV, between the generator output voltage V_{G} and the voltage V₂ of the second electrical subsystem 124 and changes the regulation voltage V_{R} to compensate for the difference in voltage. Alternatively, the voltage regulator measures the electrical current I₂ to the second electrical subsystem 124 and changes the regulation voltage V_{R} to compensate for the difference in voltage associated with the electrical current I_{R} to the second electrical subsystem 124. The difference ΔV₂ is a function of the electrical current to the second electrical subsystem 124 and may be as high as 1.5V. In one preferred embodiment, the control device 136 generates a signal to the voltage regulator indicative of a change in the regulation voltage V_{R} according to at least one of the difference ΔV₂ between the output voltage V_{G} and second voltage V₂ and the electrical current I₂ to the second electrical subsystem.

The line 116, however, presents negligible voltage drop across its length. Therefore, as the regulation voltage V_{R} is changed to compensate for the voltage drop ΔV₂, the control device 136 applies a control signal to the switch module 138 according to the difference ΔV₁ between the voltage V₁ of the first electrical subsystem 114 and the first predetermined voltage and, thus, maintains the voltage V₁ of the first electrical subsystem 114 at the first predetermined voltage V_{S}. Therefore, according to this preferred embodiment, the control device 136 operates only to ascertain the voltage V₁ of the first electrical subsystem 114 and to apply a control signal to the switch module 138 according to the difference V₁ between the voltage V₁ of the first electrical subsystem 114 and the first predetermined, voltage is regardless of the changes to the regulation voltage V_{R} which may occur as a function of the difference ΔV₂ between the generator output voltage V_{G} and the voltage V₂, of the second electrical subsystem 124.

In an alternative embodiment, the control device 138 ascertains the generator output voltage V_{G} and the voltage V₂ of the second electrical subsystem 124 and applies a control signal to the switch module 138 according to the difference ΔV₂ between the generator output voltage V_{G} and the voltage V₂. In yet another preferred embodiment, the control device 138 ascertains the electrical current I₂ to the second electrical subsystem 124 and applies a control signal to the switch module 138 according to the electrical current I₂ in order to maintain the voltage V₁ of the first electrical subsystem 114 at the first predetermined voltage V_{S}.

The control device 136 applies one or more control signals which comprise a step signal or a modulated signal depending on whether a discrete or continuous voltage control is desired. The step signal may be a switch on or a switch off signal which is applied to the switch module 138. According to one embodiment, the control device 136 applies a switch off signal to the switch module 138 when the difference ΔV₁ between the first voltage V₁and first predetermined voltage V_{S} or the difference ΔV₂between the generator output voltage V_{G} and the second voltage V₂=is greater than a threshold value ΔV_{TH}, for instance 0.7V. In another preferred embodiment the control device 136 applies a switch off signal to the switch module 138 when the electrical current I₂ to the second electrical subsystem 124 is greater than a threshold value ΔV_{TH}. According to one embodiment, the control device 136 applies a switch on signal to the switch module 138 when the difference ΔV₁between the first voltage V₁ and first predetermined voltage V_{S} or the difference ΔV₂ between the generator output voltage V_{G} and the second voltage V₂ , is less than or equal to a threshold value ΔV_{TH}. In another preferred embodiment, the control device 136 applies a switch on signal to the switch module 138 when the electrical current I₂ to the second electrical subsystem 124 is less than or equal to a threshold value I_{TH} for instance 50A.

According to one embodiment, the control device 136 applies a modulated signal to the switch module 138. The modulated signal comprises a duty cycle D which is inversely proportional to the difference ΔV₁between the first voltage V₁ and first predetermined voltage V_{S} or the difference V₂ between the generator output voltage V_{G} and the second voltage V₂. In another preferred embodiment, the duty cycle D of the modulated signal is inversely proportional to the electrical current I₂ to the second electrical subsystem 124.

According to one embodiment, the control device 136 is further configured to generate a communication signal which indicates a change in the regulation voltage V_{R} according to the difference ΔV₂ between the generator output voltage V_{G} and the second voltage V₂ or the electrical current I₂ to the second electrical subsystem 124. The communication signal will set the regulation voltage V_{R} to a first predetermined voltage V_{S} plus the difference ΔV₂, between the output voltage V_{G} second voltage V₂. Alternatively, the communication signal will set the regulation voltage V_{R} to a first predetermined voltage V_{S} plus a threshold value ΔV wherein the threshold value ΔV is proportional to the electrical current I₂ to the second electrical subsystem 124.

As an alternative to communicating the change in the regulation voltage V_{R}, the control device 136 may be further configured to operate as a voltage regulator and to regulate the output voltage V_{G} of the generator 118 via a regulating circuit (not shown but known to artisans of ordinary skill). A regulating circuit such as the one disclosed in the commonly owned U.S. Pat. No. 7,276,804 entitled “VOLTAGE REGULATOR WITH IMPROVED PROTECTION AND WARNING SYSTEM” incorporated herein by reference in its entirety, may be utilized. According to one embodiment, the control device 136 changes the regulation voltage V_{R} according to the difference ΔV₂between the generator output voltage V_{G} and the second voltage V₂ or the electrical current I ₂ to the second electrical subsystem 124. In one embodiment, the control device 136 sets the regulation voltage V_{R} to a first predetermined voltage V_{S} plus the difference ΔV, between the output voltage V_{G} and second voltage V₂. In yet another embodiment, the control device sets the regulation voltage V_{R} to a first predetermined voltage V_{S} plus a threshold value ΔV wherein the threshold value ΔV is proportional to the electrical current I₂ to the second electrical subsystem 124.

The control device 136 may be further configured to ascertain the temperatures T₁and T₂ of the first and second electrical subsystems 114 and 124, respectively. The control device utilizes the sense lines 104 and 132 to obtain the temperatures T₁ and T₂. Temperature variation affects charging requirements of the electrical energy sources 112 and 130 as known to artisans of ordinary skill. According to this embodiment, the control device 136 changes the first predetermined voltage V_{S} according to the first temperature T₁ and/or the second temperature T₂.

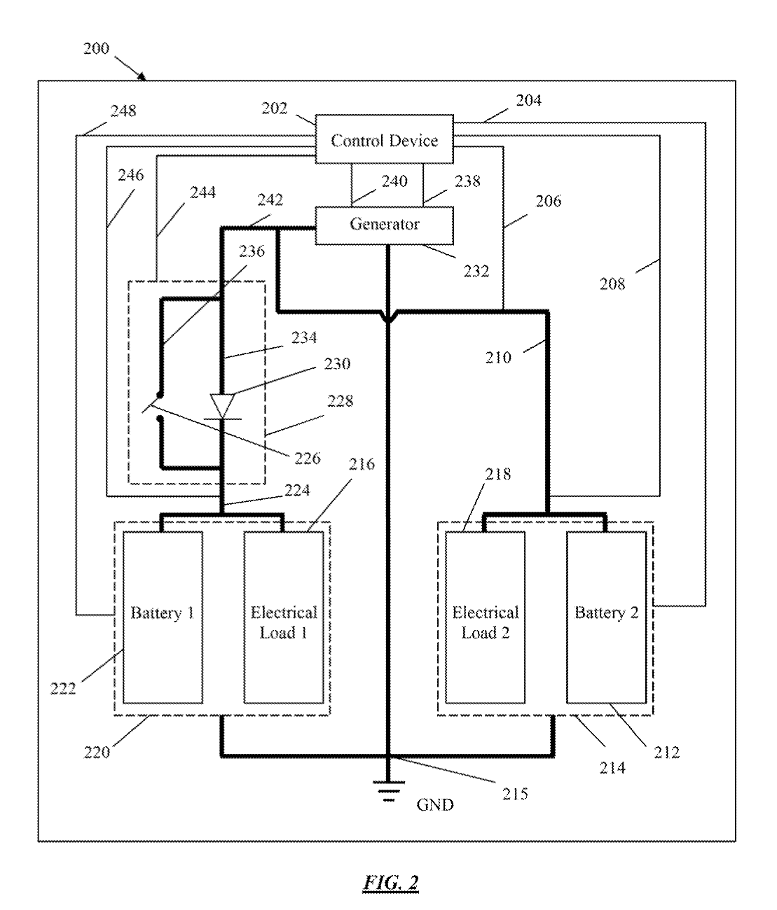

FIG. 2 shows a schematic diagram 200 of the electrical connections between the various components within the vehicle electrical system of FIG. 1 according to a preferred embodiment. The electrical system includes a control device 202, a generator 232, a first electrical subs stem 220, a second electrical subsystem 214, and a switch module 228 commonly grounded at 215. The switch module 228 comprises a diode 230 and a mechanical relay 226 The first electrical subsystem 220 comprises a first electrical load 216 which is connected to a first battery 222. The second electrical subsystem 214 comprises a second electrical load 218 which is connected to a second battery 212. The control device 202 is connected to and in (communication with the generator 232, first electrical subsystem 220 second electrical subsystem 214, and switch module 228 via lines 246, 248, 204, 206, 208, 238, 240, and 244.

According to this preferred embodiment, the control device 202 measures a first voltage V₁ of the first electrical subsystem 220 via the line 246. The control device 202 compares this voltage with a predetermined voltage V_{S} which is stored in its memory and applies a control signal to the switch module 228, via the line 244 according to a difference ΔV₁ between the first voltage V₁ and first predetermined voltage V_{S}. The control signal may be a step signal or a modulated signal. The step signal comprises either a switch on (close relay) or a switch off (open relay) signal. The modulated signal may be a pulse-width-modulation signal with duty cycle D, known to artisans of ordinary skill. The duty cycle D can be chosen to be inversely proportional to ΔV₁, ΔV₂, or I₂.

In one instance, when a difference ΔV₁ between the first voltage V₁ of the first electrical subsystem 220 and first predetermined voltage V_{S} is greater than a threshold value ΔV_{TH}, for example 0.7V, the control device 202 applies a control signal to the switch module 228, via the line 244, to open the relay switch 226. The diode 230 introduces a voltage drop which is approximately 0.7V. As a result, the first voltage V₁ of the first electrical subsystem 220 will be equal to the first predetermined voltage V_{S}. In another instance, when as difference ΔV₁between the first voltage V₁ of the first electrical subsystem 220 and first predetermined voltage V_{S} is less than or equal to a threshold value ΔV_{TH}, for example 0.7V, the control device 202 applies a control signal to the switch module 228, via the line 244, to close the relay switch 226. The voltage drop across the diode 230 which is approximately 0.7V is eliminated. As a result, the first voltage V₁ of the first electrical subsystem 220 will be equal to the first predetermined voltage V_{S}.

Alternatively, the control device 202 measures an output voltage V_{G} of the generator 232 via the line 240 and measures a second voltage V₂ of the second electrical subsystem 214 via the line 208. In one instance, when a difference ΔV₂ between the generator output voltage V_{G} and the second voltage V₂ of the second electrical subsystem 214 is greater than a threshold value the control device 202 applies a control signal to the switch module 228, via the line 244, to open the relay switch 226. The voltage drop across the diode 230 results in the first voltage V₁ to be equal to the first predetermined voltage V_{S}. In another instance, when a difference ΔV₂ , between the generator output voltage V_{G} and the second voltage V₂of the second electrical subsystem 214 is less than or equal to a threshold value Δ_{TH}, for example 0.7V, the control device 202 applies a control signal to the switch module 228, via the line 244, to close the relay switch 226. The voltage drop across the diode 230 which is approximately 0.7V is eliminated. As a result, the first voltage V₁ of the first electrical subsystem 220 will be equal to the first predetermined voltage V_{S}.

According to another embodiment, the control device 202 measures electrical current I₂ flowing to the second electrical subsystem 214 via the line 206. When the electrical current I₂ is greater than a threshold value for example 50A, the control device 202 applies a control signal to the switch module 228, via the line 244, to open the relay switch 226, introducing the voltage drop across the diode 230 and resulting in the first voltage V₁ to be equal to the first predetermined voltage V_{S}. In another instance, when the electrical current I₂ is less than or equal to a threshold value for example 50A, the control device 202 applies as control signal to the switch module 228, via the line 244, to close the relay switch 226. The voltage drop across the diode 230 which is approximately 0.7V is eliminated. As a result, the first voltage V₁ of the first electrical subsystem 220 will be equal to the first predetermined voltage V_{S}.

As stated above, the control device 202 can be configured to selectively measure V₁, V₂, V_{G} or I₂ and to apply a step signal to the switch module 228 as a function of ΔV₁, ΔV₂, or I₂. When the control device 202 is configured to apply a modulated signal, the duty cycle D of the modulated signal can be chosen to be inversely proportional to ΔV₁, ΔV₂, or I₂.

The control device 202 may he further configured to regulate the output voltage V_{G} of the generator 232 via a regulating circuit (not shown but known to artisans of ordinary skill). In a preferred embodiment, the generator 232 comprises a field coil (not shown but known to artisans of ordinary skill) whose electrical current maybe controlled via the line 238. The control device 202 regulates the output voltage V_{G} of the generator 232 by applying a control signal to the field coil via the line 238. According to one embodiment, the control device 202 changes the regulation voltage V_{R} according to a difference ΔV₂ between the generator output voltage V_{G} and the second voltage V₂. In another embodiment, the control device 202 changes the regulation voltage V_{R} according to the electrical current I₂ to the second electrical subsystem 214. According to these embodiments, the control device 202 sets the regulation voltage V_{R} to a first predetermined voltage V_{S} plus the difference ΔV, between the output voltage V_{G} and second voltage V₂, or it sets the regulation voltage V_{R} to a first predetermined voltage V_{S} plus a threshold value ΔV wherein the threshold value ΔV is proportional to the electrical current I₂ to the second electrical subsystem 214, respectively.

The control device 202 measures the temperatures T₁ and T₂ of the first and second electrical subsystems 220 and 214 via the lines 248 and 204, respectively. As known to artisans of ordinary skill, temperature variation can affect the charging requirements of the electrical energy sources 222 and 218. The control device 202 can be so configured to compensate the first predetermined voltage V_{S} tot such operating temperatures T₁and/or T²).

Utilizing the vehicle electrical system 200 described above, two embodiments of the operation of the control device 202 are now described. The generator 232 is coupled to the first electrical subsystem 220, via the switch module 228, and to the second electrical subsystem 214, via the line 208, The line 210 represents an electrical component, such as an electrical cable, which can introduce a voltage drop between the output voltage V_{G} of the generator 232 and second voltage V₂ of the second electrical subsystem 214. The voltage difference between the output voltage V_{G} of the generator 232 and second voltage V₂ of the second electrical subsystem 214 may be due to the electrical current I₂ to the second electrical subsystem 214 or it may be due to the nature of the electrical component 208 which causes such voltage drop. As such, the operation of the control device 202 is not limited to loss of voltage over long electrical cables.

In a first embodiment, the control device 202 is configured to solely ensure that the first voltage V₁ of the first electrical subsystem 220 remains at a first predetermined voltage V_{S}. According, to this embodiment, voltage regulation and change in the voltage regulation is effectuated by an external device. The control device 202 is configured to measure the first voltage V and compute the difference ΔV₁ between the first voltage V₁ and first predetermined voltage V_{S} wherein V_{S} is stored in the memory of the microprocessor included in the control device 202. An increase in V₁ occurs due an increase in the regulation voltage V_{R} caused by a voltage drop between the generator output voltage V_{G} and second voltage V₂. When ΔV₁ is greater than 0.7V, the control device 202 applies a control signal to the switch module 228, via the line 244, to open the relay switch 226. The voltage drop across the diode 230 is approximately 0.7V. As a result, the first voltage V₁ of the first electrical subsystem 220 will be equal to the first predetermined voltage V_{S} When the regulation voltage V_{R} is restored to the first predetermined voltage V_{S}, which occurs when the voltage drop between the generator output voltage V_{G}, and second voltage V₂ is eliminated, the difference ΔV₁ between the first voltage V₁ of the first electrical subsystem 220 and first predetermined voltage V_{S} is now less than 0.7V. The control device 202 applies a control signal to the switch module 228, via the line 244, to close the relay switch 226. The voltage drop across the diode 230 which is approximately 0.7V is eliminated and the first voltage V₁ of the first electrical subsystem 220 will be equal to the first predetermined voltage V_{S}.

In a second embodiment, the control device 202 is configured to not only ensure that the first voltage V₁ of the first electrical subsystem 220 remains at a first predetermined voltage V_{S}, but to also regulate the output voltage V_{G} of the generator 232 at a regulation voltage V_{R} and to further change the regulation voltage V_{R} as a function of a difference ΔV₂ between the generator output voltage V_{G} and the second voltage V₂ of the second electrical subsystem 214. As electrical load consumption by the second electrical load 218 changes, i.e. increase or decreases continuously, the electrical current I₂ through the line 210 changes continuously which causes the voltage drop ΔV₂ across the line 210 to change continuously. As such, the second voltage V₂ of the second electrical subsystem 214 changes continuously with respect to the output voltage V_{G} of the generator 232. In order to maintain the second voltage V₂ at the first predetermined, voltage V_{S}, the control device 202 continuously changes the regulation voltage V_{R} by the amount ΔV₂. The control device 202 also ensures that the first voltage V₁ of the first electrical subsystem 220 also remains at a first predetermined voltage V_{S}. The control device 202 achieves this by applying a modulated signal, the duty cycle D of which is inversely proportional to ΔV₂.

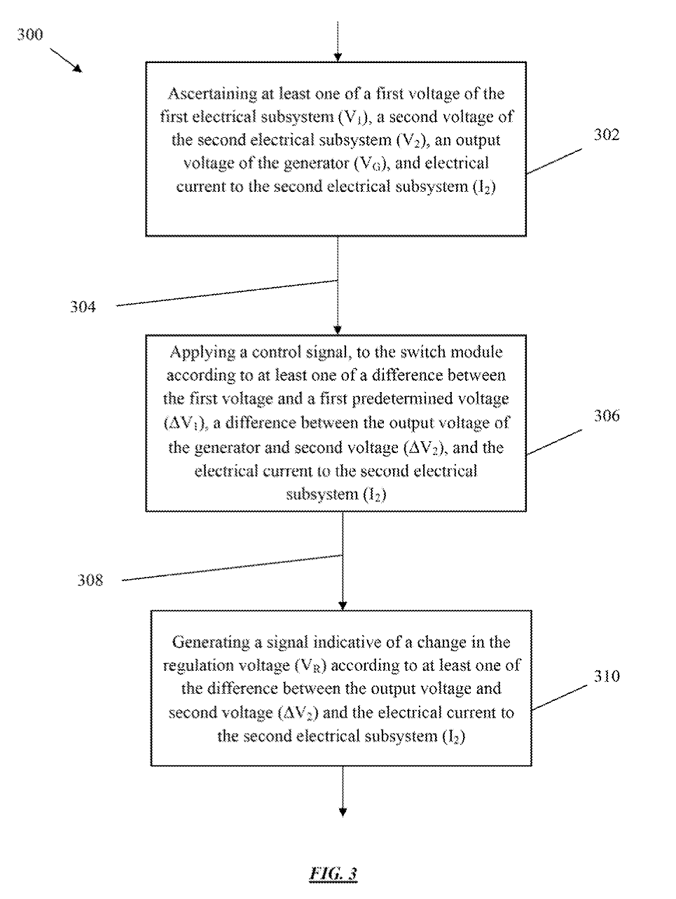

FIG. 3 is a flow diagram 300 of one preferred method of controlling a vehicle electrical system such as those depicted in FIGS. 1 and 2, the latter being used as reference to describe the method. According to this embodiment, the method comprises ascertaining at least one of a first voltage V₁ of the first electrical subsystem 114, a second voltage V₂ of the second electrical subsystem 124, an output voltage V_{G} of the generator 118, and electrical current I₂ to the second electrical subsystem 124 at 302. The quantities V₁, V₂, V_{S}, and are ascertained by direct measurement or other indirect means such as receiving them from the vehicle communication system. The method further comprises applying a control signal, to the switch module 138 according to at least one of a difference ΔV₁ between the first voltage V₁ and a first predetermined voltage V_{S}, a difference ΔV, between the output voltage V_{G} of the generator 118 and second voltage and the electrical current I₂ to the second electrical subsystem 124 at 306. The method further comprises generating a signal indicative of a change in the regulation voltage V_{R} according to at least one of the difference ΔV₂ between the output voltage V_{G} of the generator 118 and second voltage V₂ and the electrical current I₂to the second electrical subsystem 124 at 310.

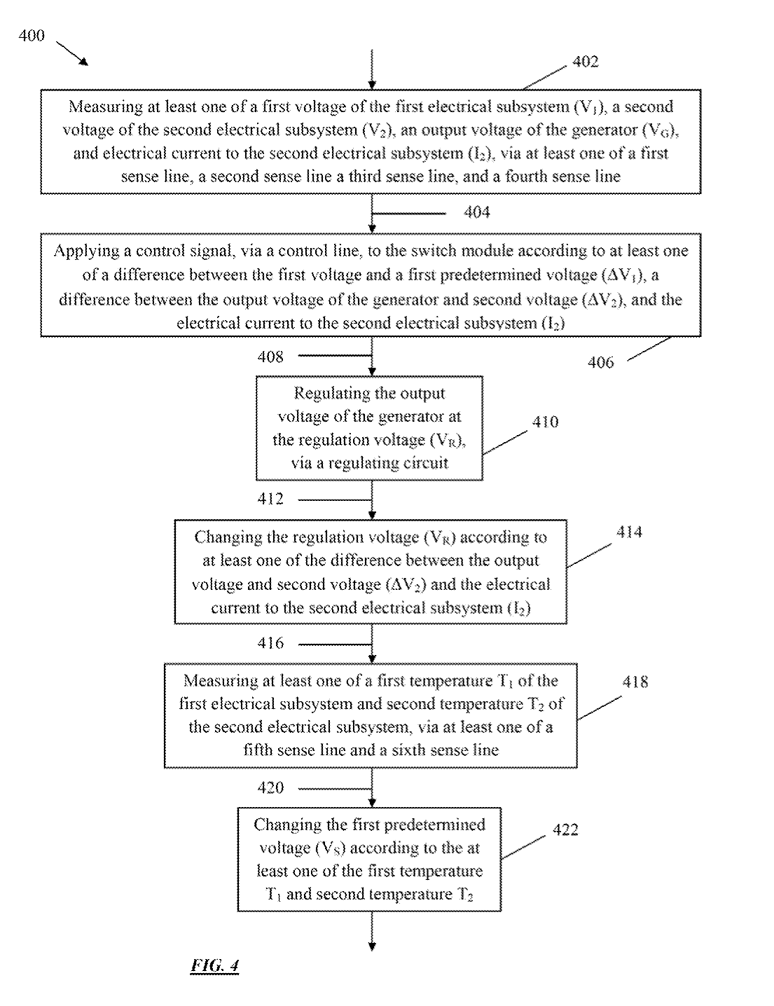

FIG. 4 is a flow diagram 400 of one preferred method of controlling a first electrical subsystem, a second electrical subsystem, and a generator via a switch module. According to this embodiment, the method comprises measuring at least one of a first voltage V₁ of the first electrical subsystem 220, a second voltage V₂ of the second electrical subsystem 214, an output voltage V_{G} of the generator 232, and electrical current I₂ to the second electrical subsystem 214, via at least one of a first sense line 246, a second sense line 208 a third sense line 240, and a fourth sense line 206 at 402. The method further comprises applying a control signal, via a control line 244, to the switch module 228 according to at least one of a difference ΔV₁ between the first voltage V₁ and a first predetermined voltage V_{S}, a difference ΔV₂ between the output voltage V_{G} of the generator 232 and second voltage V₂, and the electrical current I₂ to the second electrical subsystem 214 at 406. The method further comprises regulating the output voltage V_{G} of the generator 232 at the regulation voltage V_{R}, via a regulating circuit at 410. The method further comprises changing the regulation voltage V_{R} according to at least one of the difference ΔV₂between the output voltage V_{G} and second voltage V₂ and the electrical current I₂ to the second electrical subsystem 214 at 414. The method further comprises measuring at least one of a first temperature T₁ of the first electrical subsystem 220 and second temperature T₂ of the second electrical subsystem 214, via at least one of a fifth sense line 248 and a sixth sense line 204 at 418. The method further comprises changing the first predetermined voltage V_{S} according to the at least one of the first temperature T₁ and second temperature T₂ at 422.

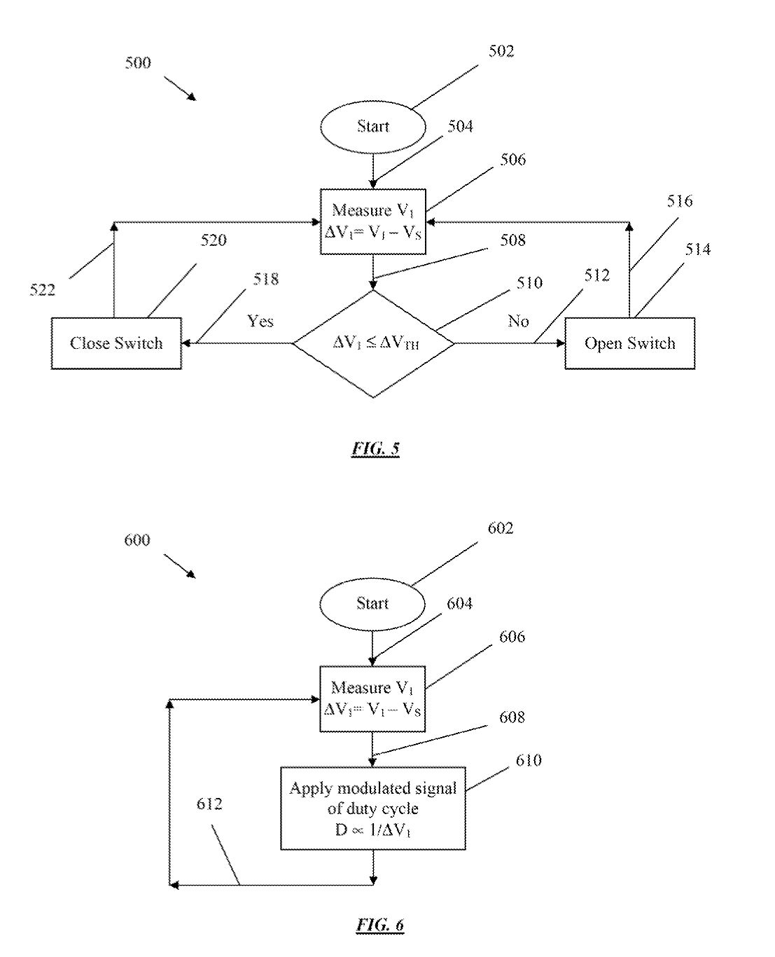

FIG. 5 is a flow 500 diagram of one preferred method of operation of the control device of FIG. 1 or 2 that maybe implemented on a processor, included in the control device, further detailing the conditions under which the control device switches the switch module to control the voltages of the first electrical subsystem, second electrical subsystem, and generator. Upon power up at 502, the processor measures the first voltage V₁ of the first electrical subsystem 220 and computes a difference ΔV₁ between the first voltage V₁and a first predetermined voltage V_{S} at 506. A comparison is made between ΔV₁ and ΔV_{TH} at 510. If the difference ΔV₁ is less than or equal to ΔV_{TH} the processor is branched at 518 and applies a control signal via the control line 244 to the switch module 228 to close the switch at 520. The processor is branched at 522 to measure the first voltage V₁ and repeats the loop at 506. If the difference ΔV₁ is greater than ΔV_{TH} the processor is branched at 512 and applies a control signal via the control line 244 to the switch module 228 to open the switch at 514. The processor is branched at 516 to measure the first voltage V₁ and repeats the loop at 506.

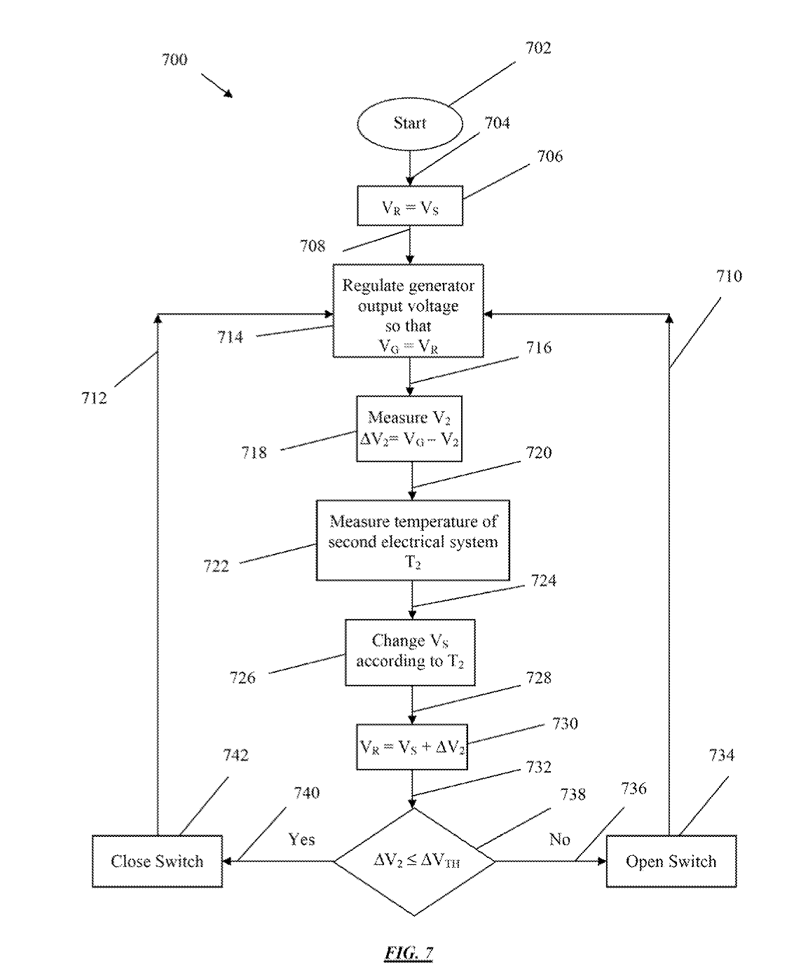

FIG. 6 is a flow diagram 600 of one preferred method of operation of the control device of FIG. 1 or 2 that maybe implemented on a processor, included in the control device, which is similar to that depicted in FIG. 5, but the control device 202 applies a modulated signal to the switch module 228. Upon power up at 602, the processor measures the first voltage V₁ of the first electrical subsystem 220 and computes a difference ΔV₁ between the first voltage V₁ and a first predetermined voltage V_{S} at 606. The processor applies a modulated signal with duty cycle D via the control line 244 to the switch module 228 at 610. The duty cycle D is proportional to the quantity 1/ΔV₁. As such, the amount of electrical power delivered to the first electrical subsystem 220 varies inversely with the difference ΔV₁ between the first voltage V₁ of the first electrical subsystem 220 and first predetermined voltage V_{S}. The processor is branched at 612 to measure the first voltage V₁and repeats the loop at 606.

FIG. 7 is a flow diagram 700 of one preferred method of operation of the control device of FIG. 1 or 2 that maybe implemented on a processor, included in the control device, further detailing the conditions under which the control device switches the switch module to control the voltages of the first electrical subsystem, second electrical subsystem, and generator. Specifically, the control device 202 further operates to regulate the output voltage V_{G} of the generator 232, make temperature compensation for the temperatures T₁ and T₁ of the first electrical subsystem 220 and second electrical subsystem 214, and vary the regulation voltage V_{R} as a function of the difference ΔV₂ between the generator output voltage V_{G} and the second voltage V₂ of the second electrical subsystem 214.

Upon power up at 702, the processor branches at 704 and sets the regulation voltage V_{R} equal to a first predetermined voltage V_{S} at 706. The processor branches at 708 and executes a voltage regulating program module at 714 which regulates the output voltage V_{G} of the generator 232 so that it is equal to V_{R}. The processor measures the second voltage V₂ of the second electrical subsystem 212 and computes a difference ΔV₂ between the output voltage V_{G} of the generator 232 and the second voltage V₂ of the second electrical subsystem 214 at 718. The processor further measures a temperature T₂ of the second electrical subsystem 214 at 722. The processor changes the predetermined voltage V_{S} according to T₂. Such temperature compensation conversion could be created in a look-up-table and readily implemented on the processor's RAM/ROM. The processor branches at 728 and sets the regulation voltage equal to said temperature compensated predetermined voltage V_{S} plus the difference ΔV₂ between the output voltage V_{G} of the generator 232 and the second voltage V₂ of the second electrical subsystem 214 at 730. A comparison is made between ΔV₂ and ΔV_{TH} at 738. If the difference ΔV₂.is less than or equal to ΔV_{TH} the processor is branched at 740 and applies a control signal via the control line 244 to the switch module 228 to close the switch at 742. The processor is branched at 712 to execute the voltage regulating program module and repeats the loop at 714. If the difference ΔV₂ is greater than ΔV_{TH} the processor is branched at 736 and applies a control signal via the control line 244 to the switch module 228 to open the switch at 734. The processor is branched at 712 to execute the voltage regulating program module and repeats the loop at 714.

The foregoing discloses a vehicle electrical system comprising a generator which delivers electrical power at a regulation voltage to two electrical subsystems. The generator is coupled with a first electrical subsystem via a switch module. A control device uses the switch module to ensure that the voltage of the first electrical subsystem remains at a first predetermined voltage in light of variations in the generator regulation voltage. The control device may be further configured to operate as a voltage regulator and effectuate the voltage regulation as well as voltage regulation variation of the generator due to electrical components' voltage losses between the generator output and second electrical subsystem.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A vehicle electrical system, comprising:
(a) a first electrical subsystem;
(b) a second electrical subsystem;
(c) a generator operative to provide electrical power at a regulation voltage to the first and second electrical subsystem;
(d) a switch module coupled with the generator and first electrical subsystem; and
(e) a control device coupled with at least one of the first electrical subsystem, second electrical subsystem, generator, and switch module;
wherein the control device is configured to:
(i) ascertain at least one of a first voltage of the first electrical subsystem, a second voltage of the second electrical subsystem, an output voltage of the generator, and electrical current to the second electrical subsystem; and
(ii) apply a control signal to the switch module according to at least one of a difference between the first voltage and a first predetermined voltage, a difference between the output voltage of the generator and second voltage, and the electrical current to the second electrical subsystem.

2. The system of claim I, wherein the control signal comprises one of a step signal and a modulated signal.

3. The system of claim 2, wherein the step signal comprises one of a switch on and a switch off signal.

4. The system of claim 3, wherein the step signal is a switch oil signal when at least one of the difference between the first voltage and first predetermined voltage and the difference between the output voltage and second voltage is greater than a threshold value.

5. The system of claim 3, wherein the step signal is a switch off signal when the electrical current to the second electrical subsystem is greater than a threshold value.

6. The system of claim 3, wherein the step signal is a switch on signal when at least one of the difference between the first voltage and first predetermined voltage and the difference between the output voltage and second voltage is less than or equal to a threshold value.

7. The system of claim 3, wherein the step signal is a switch on signal when the electrical current to the second electrical subsystem is less than or equal to a threshold value.

8. The system of claim 2, wherein a duty cycle of the modulated signal is inversely proportional to at least one of the difference between the first voltage and first predetermined voltage and the difference between the output voltage and second voltage.

9. The system of claim 2, wherein a duty cycle of the modulated signal is inversely proportional to the electrical current to the second electrical subsystem.

10. The system of claim 1, wherein the control device is further configured to generate a signal indicative of a change in the regulation voltage according to at least one of the difference between the output voltage and second voltage and the electrical current to the second electrical subsystem.

11. The system of claim 10, wherein the control device is configured to generate a signal to set the regulation voltage to a first predetermined voltage plus the difference between the output voltage and second voltage.

12. The system of claim 10, wherein the control device is configured to generate a signal to set the regulation voltage to a first predetermined voltage plus a threshold value wherein the threshold value is proportional to the electrical current to the second electrical subsystem,

13. The system of claim 1, wherein the control device is further configured to regulate the output voltage of the generator at the regulation voltage.

14. The system of claim 13, wherein the control device is further configured to change the regulation voltage according to at least one of the difference between the output voltage and second voltage and the electrical current to the second electrical subsystem.

15. The system of claim 14, wherein the control device is configured to set the regulation voltage to a. first predetermined voltage plus the difference between the output voltage and second voltage.

16. The system of claim 14, wherein the control device is configured to set the regulation voltage to a first predetermined voltage plus a threshold value wherein, the threshold value is proportional to the electrical current to the second electrical. subsystem.

17. The system of claim 1, wherein the control device is further configured to ascertain at least one of a first temperature of the first electrical subsystem and second temperature of the second electrical subsystem and change the first predetermined voltage according to the at least one of the first temperature and second temperature.

18. A method for controlling a vehicle electrical system, said system comprising a first electrical subsystem, a second electrical subsystem, a generator operative to provide electrical power at a regulation voltage to the first and second electrical subsystem, and a switch module coupled with the generator and first electrical subsystem, said method comprising:
(i) ascertaining at least one of a first voltage of the first electrical subsystem, a second voltage of the second electrical subsystem, an output voltage of the generator, and electrical current to the second electrical subsystem; and
(ii) applying a control signal to the switch module according to at least one of a difference between the first voltage and a first predetermined voltage, a difference between the output voltage of the generator and second voltage, and the electrical current to the second electrical subsystem.

19. The method of claim 18, further comprising:
(iii) generating a signal indicative of a change in the regulation voltage according to at least one of the difference between the output voltage and second voltage and the electrical current to the second electrical subsystem.

20. The method of claim 18, further comprising:
(iii) regulating the output voltage of the generator at the regulation voltage.

21. The method of claim 20, further comprising:
(iv) changing the regulation voltage according to at least one of the difference between the output voltage and second voltage and the electrical current to the second electrical subsystem.

22. The method of claim 18, further comprising:
(iii) ascertaining at least one of a first temperature of the first electrical subsystem and second temperature of the second electrical subsystem; and
(iv) changing the first predetermined voltage according to the at least one of the first temperature and second temperature.

23. A control device coupled with at least one of a first electrical subsystem, a second electrical subsystem, a generator, and a switch module, said generator operative to provide electrical power at a regulation voltage to the first and second electrical subsystem, said switch module coupled with the generator and first electrical subsystem, said control device comprising:
(a) a controller;
wherein the controller is configured to:
(i) measure at least one of a first voltage of the first electrical subsystem, a second voltage of the second electrical subsystem, an output voltage of the generator, and electrical current to the second electrical subsystem, via at least one of a first sense line, a second sense line, a third sense line, and a fourth sense line; and
(ii) apply a control signal, via a control line, to the switch module according to at least one of a difference between the first voltage and a first predetermined voltage, a difference between the output voltage of the generator and second voltage, and the electrical current to the second electrical subsystem,

24. The control device of claim 23, wherein the control signal comprises one of a step signal and a modulated signal.

25. The control device of claim 24, wherein the step signal comprises one of a witch on and a switch off signal.

26. The control device of claim 25, wherein the step signal is a switch of signal when at least one of the difference between the first voltage and first predetermined voltage and the difference between the output voltage and second voltage is greater than a threshold value.

27. The control device of claim 25, wherein the step signal is a switch off signal when the electrical current to the second electrical subsystem is greater than a threshold value.

28. The control device of claim 25, wherein the step signal is as switch on signal when at least one of the difference between the first voltage and first predetermined voltage and the difference between the output voltage and second voltage is less than or equal to a threshold value.

29. The control device of claim 25, wherein the step signal is a switch on signal when the electrical current to the second electrical subsystem is less than or equal to a threshold value.

30. The control device of claim 24, wherein a duty cycle of the modulated signal is inversely proportional to at least one of the difference between the first voltage and first predetermined voltage and the difference between the output voltage and second voltage.

31. The control device of claim 24, wherein a duty cycle of the modulated signal is inversely proportional to the electrical current to the second electrical subsystem.

32. The control device of claim 23, wherein the controller is further configured to:
(iii) generate a signal, via a communication line, indicative of a change in the regulation voltage according to at least one of the difference between the output voltage and second voltage and the electrical current to the second electrical subsystem.

33. The control device of claim 32, wherein the controller is configured to generate a signal, via the communication line, to set the regulation voltage to a first predetermined voltage plus the difference between the output voltage and second voltage.

34. The control device of claim 32, wherein the controller is configured to generate a signal, via the communication line, to set the regulation voltage to a first predetermined voltage plus a threshold value wherein the threshold value is proportional to the electrical current to the second electrical subsystem.

35. The control device of claim 23, further comprising
(b) a regulating circuit;
wherein the controller is further configured to:
(iii) regulate the output voltage of the generator at the regulation voltage, via the regulating circuit.

36. The control device of claim 35, wherein the controller is further configured to:
(iv) change the regulation voltage according to at least one of the difference between the output voltage and second voltage and the electrical current to the second electrical subsystem.

37. The control device of claim 36, wherein the controller is configured to set the regulation voltage to a first predetermined voltage plus the difference between the output voltage and second voltage.

38. The control device of claim 36, wherein the controller is configured to set the regulation voltage to a first predetermined voltage plus a threshold value wherein the threshold value is proportional to the electrical current to the second electrical subsystem.

39. The control device of claim 23, wherein the controller is further configured to:
(iii) measure at least one of a first temperature of the first electrical subsystem and second temperature of the second electrical subsystem, via at least one of a fifth sense line and a sixth sense line; and
(iv) change the first predetermined voltage according to the at least one of the first temperature and second temperature.

40. A method for controlling at least one of a first electrical subsystem, a second electrical subsystem, and a generator, said generator operative to provide electrical power at a regulation voltage to the first and second electrical subsystem, said generator coupled with the first electrical subsystem via a switch module, said method comprising:
(i) measuring, at least one of a first voltage of the first electrical subsystem, a second voltage of the second electrical subsystem, an output voltage of the generator, and electrical current to the second electrical subsystem, via at least one of a first sense line, a second sense line, a third sense line, and a fourth sense line; and
(ii) applying a control signal, via a control line, to the switch module according to at least one of a difference between the first voltage and a first predetermined voltage, a. difference between the output voltage of the generator and second voltage, and the electrical current to the second electrical subsystem.

41. The method of claim 40, further comprising:
(iii) generating a signal, via a communication line, indicative of a change in the regulation voltage according to at least one of the difference between the output voltage and second voltage and the electrical current to the second electrical subsystem.

42. The method of claim 40, further comprising:
(iii) regulating the output voltage of the generator at the regulation voltage, via a regulating circuit.

43. The method of claim 42, further comprising:
(iv) changing the regulation voltage according to at least one of the difference between the output voltage and second voltage and the electrical current to the second electrical subsystem.

44. The method of claim 40, further comprising:
(iii) measuring at least one of a first temperature of the first electrical subsystem and second temperature of the second electrical subsystem, via at least one of a fifth sense line and a sixth sense line; and
(iv) changing the first predetermined voltage according to the at least one of the first temperature and second temperature.
